(19) United States
(12) Patent Application Publication
(10) Pub. No.: US 2023/0087273 A1
(43) Pub. Date: Mar. 23, 2023

(54) ICON DISPLAY METHOD AND APPARATUS, STORAGE MEDIUM AND ELECTRONIC DEVICE

(71) Applicant: HUIZHOU TCL MOBILE COMMUNICATION CO., LTD, Huizhou, Guangdong (CN)

(72) Inventor: Yuejun Zhu, Huizhou, Guangdong (CN)

(73) Assignee: HUIZHOU TCL MOBILE COMMUNICATION CO., LTD, Huizhou, Guangdong (CN)

(21) Appl. No.: 17/905,178

(22) PCT Filed: Mar. 17, 2020
(86) PCT No.: PCT/CN2020/079763

§ 371 Date: Aug. 28, 2022

(30) Foreign Application Priority Data
Mar. 3, 2020 (CN) 202010139543.7

(51) Int. Cl. G06F 3/04817; H04W 48/16

(52) U.S. Cl. CPC G06F 3/04817; H04W 48/16

(57) ABSTRACT

Disclosed are an icon display method and apparatus, a storage medium and an electronic device. The method is applied in an electronic device and comprises: detecting whether the electronic device can access a 5G network when the electronic device accesses a 4G network; if the electronic device can access a 5G network, sending an access request to a 5G network cell, and receiving an access result returned on the basis of the access request; and determining according to the access result whether an icon of the electronic device is displayed as 5G.

This application claims the benefit of priority of a China Patent Application No. 202010139543.7 submitted to State Intellectual Property Office of the P.R.C. on Mar. 3, 2020, entitled “ICON DISPLAY METHOD AND APPARATUS, STORAGE MEDIUM AND ELECTRONIC DEVICE”, the contents of which are incorporated herein by reference in their entirety.

### TECHNICAL FIELD

The present application relates to communication technologies, and more particularly to an icon display method, apparatus, storage medium and electronic device.

### DESCRIPTION OF RELATED ARTS

5G is a new generation of mobile communication technology. There are two networking solutions, Non-Standalone (NSA) and Standalone (SA). There are obvious differences between the two. NSA is deployed based on the existing 4G infrastructure, and some services and functions still rely on 4G networks. Its advantage is that it can save building costs and implement a rapid coverage. NSA is to transmit 5G signals by modifications made to 4G base stations. The initial deployment is fast in speed and the cost is low. 5G can be widely applied as soon as possible, allowing as many users as possible to enjoy it. Conversely, SA needs to build independent base stations, and this requires higher time cost to implement a large coverage. However, SA is featured by higher speed and lower delay. In the future, with technologies developed toward SA, NSA will definitely have a long transition period. Therefore, NSA networking is the first choice considered by most operators in the early stage of 5G network construction, that is, before a complete coverage of SA, networks built by NSA networking will exist among the existing networks for a long time and coexist with SA networks. This also means that NSA/SA dual mode will be the main trend in this industry. Therefore, dual-mode 5G cell phones can provide a more complete 5G network experience in the future dual-mode 5G era.

Most 5G networks currently deployed are eMBB networks complying with NSA standard, which relies on the coverage of mature Long Term Evolution (LTE) networks (commonly known as 4G networks) and can have high throughput that is featured by gNB (a 5G base station) in a dual connectivity ENDC network. In order to be differential from the LTE network, there is a need to display a currently-connected network as 5G on a user interface (UI) when the electronic device is to connect to the dual connectivity ENDC network. However, current 5G signal icon realized by manufacturers is suspected of “false signals”, that is, there may have such a situation that the user uses a data network, the data speed is not improved as compared to the LTE network, but a 5G icon is displayed on an interface of the electronic device. If a speed test is performed, current speed may be just comparable to the LTE network speed. This will cause an inconsistency between user expectation and actual performance, leading the user to believe a fraudulent signal performance of the electronic device. This will cause an impact on product quality and brand reputation of the electronic device to some extent.

### Technical Problems

Embodiments of the present application provide an icon display method, apparatus, storage medium and electronic device, which can solve the problem that a 5G icon is displayed when the electronic device does not connect to 5G.

### Technical Solutions

An embodiment of the present application provides an icon display method, applied in an electronic device, the method including:

detecting whether the electronic device can connect to a 5G network when the electronic device connects to a 4G network;

if the electronic device can connect to the 5G network, sending an attach request to a 5G network cell, and receiving a connection result returned based on the attach request; and

determining based on the connection result whether the electronic device has an icon displayed as 5G.

The detecting whether the electronic device can connect to the 5G network includes:

obtaining a system message and a first message sent by the 4G network and received by the electronic device, and a second message sent by the electronic device;

if the system message includes a status message indicating that connection to the 4G network and the 5G network is supported, the first message is a status message indicating a grant to connect to the 5G network and the second message is a status message indicating that a capability to connect to the 5G network is equipped, determining the electronic device as being able to connect to the 5G network;

otherwise, determining the electronic device as being unable to connect to the 5G network.

The icon display method further includes determining to display the icon of the electronic device as 4G if the electronic device is unable to connect to the 5G network.

The determining based on the connection result whether the electronic device has the icon displayed as 5G includes:

if the connection result shows a successful connection, determining to display the icon of the electronic device as 5G;

if the connection result shows a connection failure, determining to display the icon of the electronic device as 4G.

The determining to display the icon of the electronic device as 5G includes:

if a frequency band used to connect to the 5G network cell belongs to a first frequency band, determining to display the icon of the electronic device as 5G;

if the frequency band used to connect to the 5G network cell belongs to a second frequency band, determining to display the icon of the electronic device as 5G ultra wideband.

The sending the connection result to the 5G network cell and receiving the connection result returned based on the connection result includes:

receiving a measurement control message sent via the 4G network;

detecting 5G cells neighboring the 4G network based on the measurement control message, and sending a measurement report of the 5G neighboring cells;

sending the attach request to the 5G network cell among the 5G neighboring cells, wherein the 5G network cell is determined from the 5G neighboring cells based on the measurement report by the 4G network;

receiving the connection result returned based on the attach request.

The sending the attach request to the 5G network cell among the 5G neighboring cells includes:

receiving radio resource control reconfiguration and bearer configuration messages of the 5G network cell sent via the 4G network;

detecting whether the radio resource control reconfiguration and the bearer configuration are finished;

after the radio resource control reconfiguration and the bearer configuration are finished, receiving a random access configuration message sent by the 5G network cell and sending the attach request for random access to the 5G network cell based on the random access configuration message.

An embodiment of the present application provides an icon display apparatus, applied in an electronic device, including:

a detecting unit, configured for detecting whether the electronic device can connect to a 5G network when the electronic device connects to a 4G network;

a connecting unit, configured for sending an attach request to a 5G network cell and receiving a connection result returned based on the attach request if the electronic device can connect to the 5G network; and

a display determining unit, configured for determining based on the connection result whether the electronic device has an icon displayed as 5G.

The detecting unit is configured for:

obtaining a system message and a first message sent by the 4G network and received by the electronic device, and a second message sent by the electronic device;

if the system message includes a status message indicating that connection to the 4G network and the 5G network is supported, the first message is a status message indicating a grant to connect to the 5G network and the second message is a status message indicating that a capability to connect to the 5G network is equipped, determining the electronic device as being able to connect to the 5G network;

otherwise, determining the electronic device as being unable to connect to the 5G network.

The display determining unit is further configured for determining to display the icon of the electronic device as 4G if the electronic device is unable to connect to the 5G network.

The display determining unit is configured for:

if the connection result shows a successful connection, determining to display the icon of the electronic device as 5G;

if the connection result shows a connection failure, determining to display the icon of the electronic device as 4G.

The display determining unit is configured for:

if a frequency band used to connect to the 5G network cell belongs to a first frequency band, determining to display the icon of the electronic device as 5G;

if the frequency band used to connect to the 5G network cell belongs to a second frequency band, determining to display the icon of the electronic device as 5G ultra wideband.

The connecting unit is configured for:

receiving a measurement control message sent via the 4G network;

detecting 5G cells neighboring the 4G network based on the measurement control message, and sending a measurement report of the 5G neighboring cells;

sending the attach request to the 5G network cell among the 5G neighboring cells, wherein the 5G network cell is determined from the 5G neighboring cells based on the measurement report by the 4G network;

receiving the connection result returned based on the attach request.

The connecting unit is configured for:

receiving radio resource control reconfiguration and bearer configuration messages of the 5G network cell sent via the 4G network;

detecting whether the radio resource control reconfiguration and the bearer configuration are finished;

after the radio resource control reconfiguration and the bearer configuration are finished, receiving a random access configuration message sent by the 5G network cell and sending the attach request for random access to the 5G network cell based on the random access configuration message.

An embodiment of the present application provides a computer readable storage medium, storing a plurality of instructions applicable to be loaded by a processor to execute any of the afore-mentioned icon display methods.

An embodiment of the present invention provides an electronic device, including a processor and a storage that are electrically connected to each other, the storage configured to store instructions and data, the processor configured to execute any of the afore-mentioned icon display methods.

### Beneficial Effects

In the icon display method, apparatus, storage medium and electronic device provided in the present application, after the electronic device connects to the 4G network, an attach request is sent to the 5G network cell that is determined from the 5G cells neighboring the 4G network, and the connection result returned based on the attach request is received; and whether the electronic device has an icon displayed as 5G is determined based on the connection result. In the embodiments of the present application, after the connection result of the 5G network cell is received, the icon of the electronic device is determined to be displayed as 5G based on the connection result. This prevents the electronic device from displaying the 5G icon when the connection to the 5G network is not succussed. That is, this avoids a display of “fake 5G signals” by the 5G signal icon of the electronic device. This improves user experience.

### BRIEF DESCRIPTION OF THE DRAWINGS

The technical solutions and other beneficial effects of the present application will be more apparent with reference to the detailed descriptions of the embodiments of the present application below in accompanying with the drawings.

FIG. 1 is a diagram illustrating a system architecture of an ENDC network provided by an embodiment of the present application.

FIG. 2 is a schematic flowchart of an icon display method provided by an embodiment of the present application.

FIG. 3 is a schematic diagram illustrating a process flow for an electronic device to connect to a 4G network according to an embodiment of the present application.

FIG. 4 is a schematic diagram illustrating a process flow for an electronic device to determine whether it is able to connect to a 5G network according to an embodiment of the present application.

FIG. 5 is a schematic diagram illustrating a process flow for an electronic device to connect to a 5G network according to an embodiment of the present application.

FIG. 6 is a structural schematic diagram illustrating an icon display apparatus provided by an embodiment of the present application.

FIG. 7 is a schematic diagram illustrating a type of structure of an electronic device provided by an embodiment of the present application.

FIG. 8 is a schematic diagram illustrating another type of structure of an electronic device provided by an embodiment of the present application.

### DETAILED DESCRIPTION

The technical solutions in the embodiments of the present application are clearly and completely described below with reference to appending drawings of the embodiments of the present application. Obviously, the described embodiments are merely a part of embodiments of the present application and are not all of the embodiments. Based on the embodiments of the present application, all the other embodiments obtained by those of ordinary skill in the art without making any inventive effort are within the scope the present application.

Embodiments of the present application provide an icon display method, apparatus, storage medium and electronic device. Any one type of icon display devices provided in the embodiments of the present application may be integrated in an electronic device. The electronic device may include a mobile terminal, a wearable device, a PC terminal, a robot, etc. The electronic device is able to connected to a network.

Before introducing the embodiments of the present invention, terminologies involved in this patent application will be explained first, as follows:

User Equipment (UE): in the 3rd Generation Mobile Communications (3G) and 4G networks, a user terminal, an electronic device in the embodiments of the present application, is called a UE.

UMTS Terrestrial Radio Access Network (UTRAN): in 3G networks, the access network is called UTRAN.

Evolved UMTS Terrestrial Radio Access Network (E-UTRAN): in Long Term Evolution (LTE) networks (commonly known as 4G networks), the access network is called E-UTRAN, derived from the name “evolution”. It is also known as a mobile communication wireless network in LTE.

Mobility Management Entity (MME) is a key control node of an LTE access network in the 3GPP protocol and is in charge of positioning and paging a UE in an idle mode, including a relay function. Simply speaking, the MME is in charge of signaling processing. It involves bearer activation/deactivation. When a UE is initialized and connected, it selects a Serving GateWay (S-GW) for the UE.

An evolved Node B (eNB) refers to a base station of the 4G network, where NB refers to a base station of the 3G network. A gNB refers to a base station of a 5G network, which can also be represented by en-gNB.

An evolved Packet Core (EPC) is a 4G core network, also known as LTE core network.

An E-UTRAN NR Dual Connectivity (ENDC) network, a network with dual connectivity, is simply understood as connecting a 4G network and a 5G network at the same time, for example, a 4G and 5G dual connectivity network taking 4G as an anchor point.

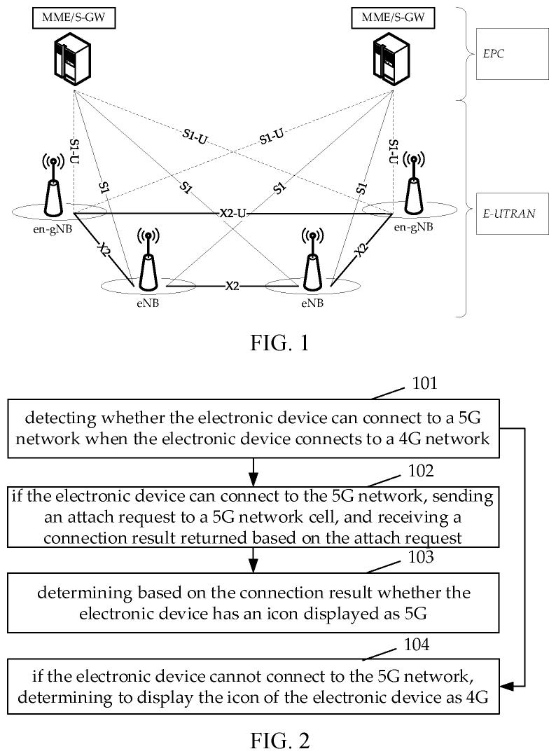

FIG. 1 is a diagram illustrating a system architecture of an ENDC network provided by an embodiment of the present application. The eNB refers to a base station of the 4G network. The en-gNB refers to a base station of the 5G network. The base stations of the 4G network are connected to each other via X2 interfaces. The base stations of the 4G network and the base stations of the 5G network are also connected via the X2 interfaces. The base stations of the 4G network are connected to the EPC core network via X1 interfaces. The base stations of the 5G network are connected to each other via X2-U interfaces. The base stations of the 5G network are connected to the EPC core network via X1-U interfaces. The part including MME and S-GW is called a 4G core network. The plurality of base stations are called access networks.

FIG. 2 is a schematic flowchart of an icon display method provided by an embodiment of the present application. The method is applied in an electronic device. The icon display method includes Steps 101 to 104, which may be detailed as follows:

Step 101: detecting whether the electronic device can connect to a 5G network when the electronic device connects to a 4G network.

When the electronic device connects to the 4G network, the electronic device will receive a system message and a first message sent by the 4G network and the electronic device will send a second message. The system message is a status message indicating whether connection to the 4G network and the 5G network is supported or not. The first message is a status message indicating a grant to connect to the 5G network. The second message is a status message indicating whether a capability to connect to the 5G network is equipped.

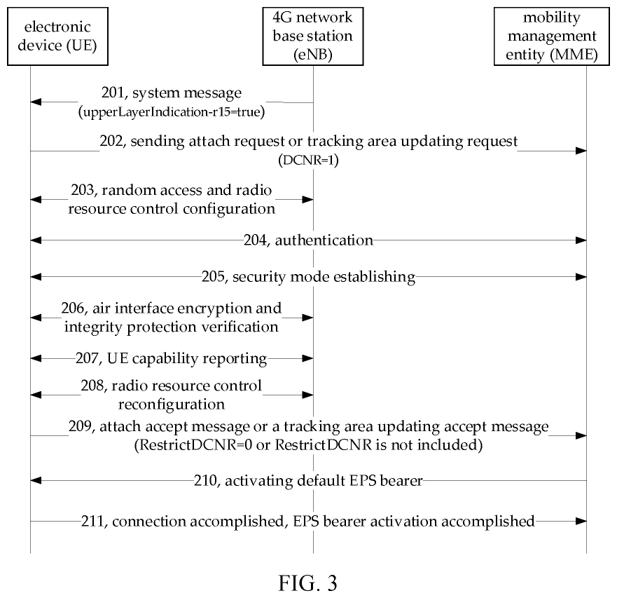

The steps for the electronic device to connect to the 4G network are shown in FIG. 3 with the following steps:

In Step 201, an electronic device (UE) receives a system message sent by a base station (eNB) of a 4G network. The system message is a status message indicating whether connection to the 4G network and the 5G network at the same time is supported or not.

Specifically, an E-UTRAN cell will broadcast via the system message based on an operator's configuration to indicate whether it supports dual connectivity. It can be understood that according to network planning, some base stations will support Non-Standalone (NSA), and some base stations do not support NSA. This is determined by the deployment made by the operator. Based on the operator's configuration, the base station (eNB) of the 4G network will broadcast via the system message to indicate whether the 4G network supports dual connectivity, that is, identifying a status message indicating whether connection to the 4G network and the 5G network at the same time is supported or not. The system message will carry an upperLayerIndication-r15 field. After receiving the upperLayerIndication-r15 field, the electronic device saves a value in the field in a modem database.

If the value in the upperLayerIndication-r15 field is a truth value, it means that the current 4G network can be used as an anchor network for a dual connectivity (ENDC) network, that is, a status message indicating that connection to the 4G network and the 5G network at the same time is supported is indicated. If the value in the upperLayerIndication-r15 field is a false value, it means that the current 4G network cannot be used as an anchor network for a dual connectivity (ENDC) network, that is, a status message indicating that connection to the 4G network and the 5G network at the same time is not supported is indicated. If the value in the upperLayerIndication-r15 field is a false value, it means a status message indicating that connection to the 4G network and the 5G network at the same time is not supported is indicated, and then the icon of the electronic device is displayed as 4G.

In Step 202, the electronic device sends an Attach Request or a Tracking Area Updating Request (TAU Request) to a mobility management entity (MME).

The attach request or the tracking area updating request can be outputted by using an LTE NAS EMM Plain OTA Outgoing Message. The LTE NAS EMM Plain OTA Outgoing Message can be easily understood as a message outputted by a specification protocol. The attach request or the tracking area updating request includes a second message, or it is understood as being that the attach request or the tracking area updating request will carry a DCNR field, where the DCNR field represents a status message indicating whether the electronic device has a capability to connect to the 5G network. If the value of this field is 1, it represents a status message indicating that the capability to connect to the 5G network is equipped. If the value of this field is 0, it represents a status message indicating that the capability to connect to the 5G network is not equipped.

Obtain the second message, and save the value of the DCNR field corresponding to the second message in the modem database.

If the second message is a status message indicating that the capability to connect to the 5G network is not equipped, the electronic device is determined as being unable to connect to the 5G network.

In Step 203, the electronic device performs random access to the base station of the 4G network and implements radio resource control (RRC) configuration.

In Step 204, authentication is performed between the electronic device and the mobility management entity.

Send an Authentication Request and receive a Response.

Specifically, corresponding authentication request and response message can be obtained by an LTE NAS EMM Plain OTA Incoming/Outgoing Message specification protocol.

In Step 205, a security mode is established between the electronic device and the mobility management entity.

Specifically, corresponding security mode commands and response message can be obtained by an LTE NAS EMM Plain OTA Incoming/Outgoing Message specification protocol. The security mode is established by transmission of security mode commands between the electronic device and the mobility management entity. After the security mode is established, a completion message is sent.

In Step 206, air interface encryption and integrity protection verification are implemented between the electronic device and the base station of the 4G network.

For example, the integrity protection verification includes a check on whether data is complete or not.

In Step 207, the electronic device reports capability information to the base station of the 4G network.

Specifically, the base station of the 4G network sends information about capability querying to the electronic device, and based on the information about capability querying, the electronic device reports the capability information. The capability information includes information about supported data capability, frequency band, coding schemes for various voice capabilities, and so on.

In Step 208, radio resource control reconfiguration is implemented between the electronic device and the base station of the 4G network.

The radio resource control reconfiguration includes measurement configuration and radio bearer configuration. Specifically, for example, the base station of the 4G network sends measurement configuration information and radio bearer configuration information to the electronic device, and the electronic device implements the measurement configuration and the radio bearer configuration according to the measurement configuration information and the radio bearer configuration information.

In Step 209, the electronic device receives an attach accept message or a tracking area accept message.

The attach accept message (Attach Accept) or the tracking area updating accept message (TAU Accept) can be obtained by using an LTE NAS EMM Plain OTA Incoming Message specification protocol. The mobility management entity obtains information about whether the electronic device is restricted to access (Access Restrict for NR) and sends the information to the electronic device. For example, the mobility management entity notifies the base station of the 4G network via a 51 message in a form of a Handover Restriction List (HRL). The base station of the 4G network notifies the electronic device of whether the network restricts the accessing from the electronic device in the attach accept message or the tracking area updating accept message. The electronic device receives the attach accept message or the tracking area updating accept message. The attach accept message or the tracking area updating accept message carries the first message. The first message is a status message indicating whether to grant the connecting to the 5G network or not. Specifically, if the attach accept message or the tracking area updating accept message does not carry a RestrictDCNR field, or carries the RestrictDCNR field but the value of the RestrictDCNR field is 0, it means that the first message is a status message indicating a grant to connect to the 5G network. If the attach accept message or the tracking area updating accept message carries the RestrictDCNR field but the value of the RestrictDCNR field is not 0, it means that the first message is a status message indicating that it is not allowed to connect to the 5G network.

Obtain the value of the RestrictDCNR field and write the value of the RestrictDCNR field to the modem database. Alternatively, if the RestrictDCNR field is not carried, write to the modem database information representing that the RestrictDCNR field is not carried.

If the first message is a status message indicating that it is not allowed to connect to the 5G network, the electronic device is determined as being unable to connect to the 5G network.

In Step 210, a default Evolved Packet System (EPS) bearer is activated between the electronic device and the MME. The connection to the 4G network is accomplished. The activation of the EPS bearer is done.

The connecting to the 4G network is briefly described above. It should be noted that there are many details for the electronic device to connect to the 4G network, and these are not described in detail in the embodiments of the present application.

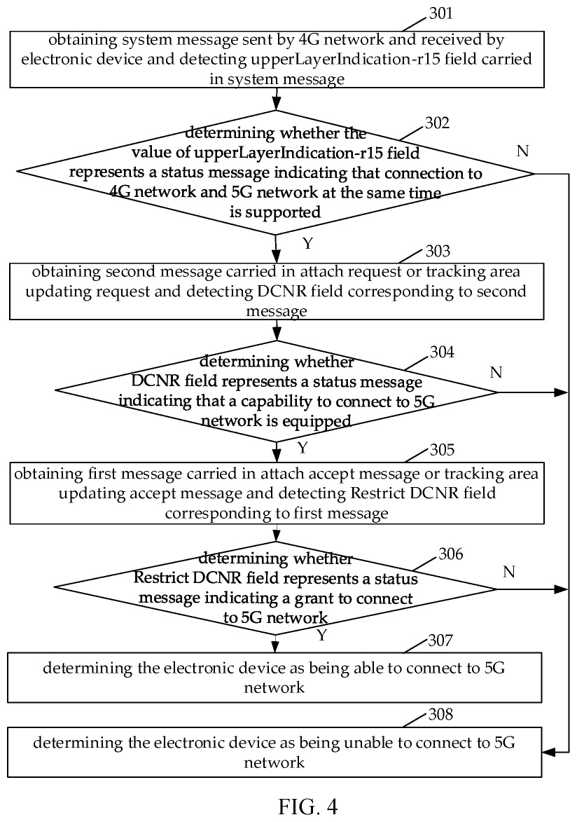

Specifically, detecting whether the electronic device is able to connect to the 5G network is shown in FIG. 4 with Steps 301 to 308.

In Step 301, a system message sent by the 4G network and received by the electronic device is obtained, and detecting an upperLayerindication-r15 field carried in the system message is performed.

In Step 302, whether the value of the upperLayerIndication-r15 field represents a status message indicating that connection to the 4G network and the 5G network is supported at the same time is determined. For example, whether the value of the upperLayerindication-r15 field is a truth value is determined. If it is a truth value, it represents a status message indicating that connection to the 4G network and the 5G network at the same time is supported; and if it is not a truth value, it represents a status message indicating that connection to the 4G network and the 5G network at the same time is not supported.

If the value of the upperLayerindication-r15 field represents a status message indicating that connection to the 4G network and the 5G network at the same time is supported, Step 303 is performed; otherwise, Step 308 is performed.

In Step 303, a second message carried in the attach request or the tracking area updating request is obtained, and detecting a DCNR field corresponding to the second message is performed.

In Step 304, whether the DCNR field represents a status message indicating that a capability to connect to the 5G network is equipped is determined.

For example, whether the value of the DCNR field is 1 is determined. If it is 1, it represents a status message indicating that a capability to connect to the 5G network is equipped; and if it is not 1, it represents a status message indicating that a capability to connect to the 5G network is not equipped.

If the DCNR field represents a status message indicating that a capability to connect to the 5G network is equipped, Step 305 is performed; otherwise, Step 308 is performed.

In Step 305, a first message carried in the attach accept message or the tracking area updating accept message is obtained, and detecting a Restrict DCNR field corresponding to the first message is performed.

It should be noted that if Step 303 has the attach request, this step has a corresponding attach accept message; and if Step 303 has the tracking area updating request, this step has a corresponding tracking area updating accept message.

In Step 306, whether the Restrict DCNR field represents a status message indicating a grant to connect to the 5G network is determined.

For example, when the Restrict DCNR field is not detected (it can be understood as being supported by default) or the value of the Restrict DCNR field is 0, it is determined that the Restrict DCNR field represents a status message indicating a grant to connect to the 5G network; and if the Restrict DCNR field is detected and the value of the Restrict DCNR field is 1, it is determined that the Restrict DCNR field represents a status message indicating that it is not allowed to connect to the 5G network.

If it is determined that the Restrict DCNR field represents a status message indicating a grant to connect to the 5G network, Step 307 is performed; otherwise, Step 308 is performed.

In Step 307, it is determined that the electronic device is able to connect to the 5G network. Then, Step 309 is performed.

In Step 308, it is determined that the electronic device is unable to connect to the 5G network.

Steps 301 to 308 are detailed procedures for detecting whether the electronic device is able to connect to the 5G network. It can be understood that the system message, the first message and the second message can be obtained directly from the modem database or can be obtained in receiving or sending corresponding messages. For example, the second message is obtained in the received attach accept message (Attach Accept) or tracking area updating accept message (TAU Accept), and the first message is obtained in the attach request (Attach Request) or tracking area updating request (TAU Request).

If the electronic device can connect to the 5G network, Step 102 is performed; and if the electronic device cannot connect to the 5G network, Step 104 is performed.

Step 102: sending an attach request to a 5G network cell, and receiving a connection result returned based on the attach request.

It should be noted that the attach request in this step refers to a 5G network attach request. This is different from the attach request in FIG. 3. The attach request in FIG. 3 refers to a 4G network attach request.

If the electronic device is able to connect to the 5G network, the electronic device is determined as being able to connect to a dual connectivity network. In the dual connectivity network, the eNB acts as a Master Node (MN), also called a primary base station; and the en-gNB acts as a Secondary Node (SN), also called a secondary base station.

Specifically, Step 102 includes receiving a measurement control message sent via the 4G network; detecting 5G cells neighboring the 4G network based on the measurement control message, and sending a measurement report of the 5G neighboring cells; sending the connection request to the 5G network cell among the 5G neighboring cells, wherein the 5G network cell is determined from the 5G neighboring cells based on the measurement report by the 4G network; receiving the connection result returned based on the attach request.

If the primary base station (eNB) detects that the electronic device is able to connect to the 5G network, the measurement control message is sent via the eNB. The measurement control message includes measurement configuration and events for measurement reporting. The electronic device receives the measurement control message and measures the 5G cells neighboring the 4G network according to the measurement control message. There may have a plurality of 5G network cells within the coverage of the 4G network, and the 5G neighboring cells include the plurality of 5G network cells. Measuring the 5G neighboring cells includes measuring the signal strength of the 5G network cells. When the measured signal strength of the 5G network cells reaches the signal strength determined in the events for measurement reporting, a measurement report on these 5G network cells will be sent to the primary base station.

The primary base station receives the measurement report sent by the electronic device, determines an optimal 5G network cell based on preset rules from the 5G network cells that are reported in the measurement report, and determines the optimal 5G network cell as the 5G network cell to which the electronic device is to be connected. An attach request is sent to the optimal 5G network cell, and a connection result returned based on the attach request is received.

The sending the access request to the 5G network cell (for example, the optimal 5G network cell determined based on the preset rules) of the 5G network includes receiving radio resource control reconfiguration and bearer configuration messages of the 5G network cell sent via the 4G network; detecting whether the radio resource control reconfiguration and the bearer configuration are finished; after the radio resource control reconfiguration and the bearer configuration are finished, receiving a random access configuration message sent by the 5G network cell and sending the attach request for random access to the 5G network cell based on the random access configuration message; if the radio resource control reconfiguration and the bearer configuration are not finished, determining the connection result as being a connection failure.

Specifically, the secondary base station (en-gNB) sends the radio resource control reconfiguration and bearer configuration messages of the 5G network cell (also referred to as a secondary cell group (SCG)) to the primary base station via an X2 interface, and the primary base station sends the received radio resource control reconfiguration and bearer configuration messages to the electronic device. It should be noted that since a connection between the secondary base station and the electronic device has not been created in the dual connectivity network at this time, the radio resource control reconfiguration and bearer configuration messages are still transmitted via the 4G network. Whether the radio resource control reconfiguration and bearer configuration of the 5G network cell are finished is detected. If it is finished, the electronic device will send a completion message to the secondary base station to indicate that the configuration is finished. When the secondary base station receives the completion message sent by the electronic device, a communication connection between the electronic device and the secondary base station is established. After the communication connection is established, the secondary base station sends a random access configuration message (MR5G RRC MIB message) to the electronic device. After receiving the random access configuration message sent by the secondary base station, the electronic device sends an attach request for random access to the 5G network cell based on the random access configuration message.

The secondary base station will send a connection result to the electronic device based on the attach request. That is, the electronic device receives the connection result returned based on the attach request.

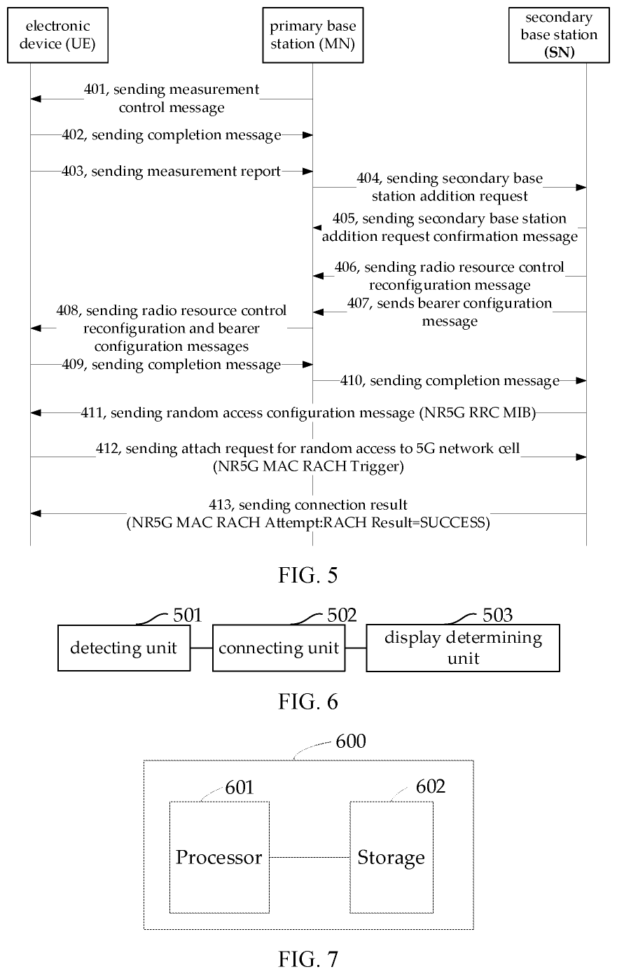

The steps for the electronic device to connect to the 5G network cell are shown in FIG. 5 with the following Steps 401 to 413:

In Step 401, the primary base station sends a measurement control message to the electronic device.

The measurement control message includes measurement configuration and events for measurement reporting.

In Step 402, the electronic device sends a completion message to the primary base station to indicate that the measurement is finished.

The electronic device receives the measurement control message and measures 5G cells neighboring the 4G network based on the measurement control message. If the measurement is finished, the electronic device sends the completion message to the primary base station.

In Step 403, the electronic device sends a measurement report to the primary base station.

When measured signal strength of 5G network cells reaches the signal strength determined in the events for measurement reporting, the measurement report on the 5G network cells will be sent to the primary base station.

In Step 404, the primary base station sends a secondary base station addition request to the secondary base station.

The primary base station determines an optimal 5G network cell based on preset rules from the received measurement report on the 5G network cells, and sends the secondary base station addition request (Addition Request) to a secondary base station corresponding to the optimal 5G network cell. The secondary base station addition request is used to request the secondary base station to serve as the secondary base station of the electronic device, and the secondary base station addition request carries related information for connecting to the primary base station.

In Step 405, the secondary base station sends a secondary base station addition request confirmation message to the primary base station.

In Step 406, the secondary base station sends radio resource control reconfiguration of the 5G network cell to the primary base station.

In Step 407, the secondary base station sends a bearer configuration message of the 5G network cell to the primary base station.

In Step 408, the primary base station sends the radio resource control reconfiguration and bearer configuration messages of the 5G network cell to the electronic device.

After receiving the radio resource control reconfiguration and bearer configuration messages sent by the secondary base station, the primary base station packs up the radio resource control reconfiguration and bearer configuration messages and sends that to the electronic device.

In Step 409, the electronic device implements radio resource control reconfiguration and bearer configuration based on the radio resource control reconfiguration and bearer configuration messages, and sends a completion message to the primary base station to indicate that the configuration is finished after the radio resource control reconfiguration and the bearer configuration are implemented.

In Step 410, the primary base station forwards the completion message sent by the electronic device to the secondary base station.

So far, a communication connection is established between the secondary base station and the electronic device.

In Step 411, the secondary base station sends a random access configuration message to the electronic device.

Specifically, for example, an NR5G RRC MIB message is sent.

In Step 412, after receiving the random access configuration message, the electronic device sends an attach request for random access to the 5G network cell based on the random access configuration message.

In Step 413, the secondary base station sends a connection result based on the attach request to the electronic device. The connection result includes a successful connection or a connection failure. Specifically, the connection result (RACH Result) is carried in a NR5G MAC RACH Attempt message. For example, if the RACH Result=SUCCESS, it means a successful connection; otherwise, the connection is failed.

This embodiment describes in details how the electronic device connects to the 5G network cell when the electronic device is able to connect to the 5G network.

After receiving the RACH Result, the electronic device saves the connection result corresponding to the RACH Result in the modem database.

Step 103: determining based on the connection result whether the electronic device has an icon displayed as 5G.

Specifically, Step 103 includes determining to display the icon of the electronic device as 5G if the connection result shows a successful connection; and determining to display the icon of the electronic device as 4G if the connection result shows a connection failure.

It can be understood that the value of the upperLayerindication-r15 field is checked upon reception of the system message, the value of the DCNR field is checked upon transmission of the attach request or the tracking area updating request to the base station of the 4G network, the value of the RestrictDCNR field is checked upon reception of the attach accept message or the tracking area accept message, and the value of the RACH Result is checked upon reception of the NR5G MAC RACH Attempt message. If all of the foregoing values meet corresponding requirement, that is, if the system message includes a status message indicating that connection to the 4G network and the 5G network at the same time is supported, the first message is a status message indicating a grant to connect to the 5G network, the second message is a status message indicating that a capability to connect to the 5G network is equipped and the connection result shows a successful connection, the icon of the electronic device is determined to be displayed as 5G; otherwise, the icon of the electronic device is determined to be displayed as 4G. That is, when the electronic device is able to connect to the 5G network but it is failed to connect to the 5G network, the icon of the electronic device is displayed as 4G.

Further, the determining to display the icon of the electronic device as 5G includes determining to display the icon of the electronic device as 5G if a frequency band used to connect to the 5G network cell belongs to a first frequency band; determining to display the icon of the electronic device as 5G ultra wideband (5G UWB) if the frequency band used to connect to the 5G network cell belongs to a second frequency band. The wavelength corresponding to the second frequency band is smaller than the wavelength corresponding to the first frequency band. The frequencies of waves corresponding to the second frequency band are higher than the frequencies of waves corresponding to the first frequency band.

Step 104: determining to display the icon of the electronic device as 4G

That is, if the electronic device is unable to connect to the 5G network, the icon of the electronic device is determined to be displayed as 4G.

In this embodiment, when the electronic device is able to connect to the 5G network, a judgement on whether the connection to the 5G network cell is succussed is added to determine whether to display the 5G icon, and when the 5G status is changed, the icon of the electronic device is updated. This prevents the electronic device from displaying the 5G icon when the connection to the 5G network is not succussed. What is perceived by a user is a real display of 5G network and an improved experience on 5G high speed. There is no need to worry about a display of “fake 5G signals”. This addresses the problem of “fake 5G signals” displayed on the display device.

The embodiments of the present application are applicable to the electronic devices connected to a dual connectivity network, especially to the electronic devices performing initial access and tracking area updating. The initial access includes situations such as powering on the electronic device or re-plugging a SIM card.

Based on the method described in the foregoing embodiments, this embodiment will be further described from the perspective of an icon display apparatus. The icon display apparatus can be implemented as an independent entity or integrated in an electronic device. The electronic device may include a mobile terminal, a wearable device, a PC terminal, a robot, etc. The electronic device is able to connect to a network.

FIG. 6 describes in details an icon display apparatus provided by an embodiment of the present application, which is applied in an electronic device. The icon display apparatus may include a detecting unit 501, a connecting unit 502 and a display determining unit 503.

The detecting unit 501 is configured for detecting whether the electronic device can connect to a 5G network when the electronic device connects to a 4G network.

Specifically, the detecting unit 501 is configured for obtaining a system message and a first message sent by the 4G network and received by the electronic device, and a second message sent by the electronic device; if the system message includes a status message indicating that connection to the 4G network and the 5G network is supported, the first message is a status message indicating a grant to connect to the 5G network and the second message is a status message indicating that a capability to connect to the 5G network is equipped, determining the electronic device as being able to connect to the 5G network; otherwise, determining the electronic device as being unable to connect to the 5G network.

Further, the detecting unit 501 is configured for obtaining a system message sent by the 4G network and received by the electronic device and determining whether the value of an upperLayerIndication-r15 field represents a status message indicating that connection to the 4G network and the 5G network at the same time is supported; if the value of the upperLayerIndication-r15 field represents a status message indicating that connection to the 4G network and the 5G network at the same time is not supported, determining the electronic device as being unable to connect to the 5G network; if the value of the upperLayerIndication-r15 field represents a status message indicating that connection to the 4G network and the 5G network at the same time is supported, obtaining a second message carried in the attach request or the tracking area updating request, and detecting a DCNR field corresponding to the second message; determining whether the DCNR field represents a status message indicating that a capability to connect to the 5G network is equipped; if the DCNR field represents a status message indicating that a capability to connect to the 5G network is not equipped, determining the electronic device as being unable to connect to the 5G network; if the DCNR field represents a status message indicating that a capability to connect to the 5G network is equipped, obtaining a first message carried in the attach accept message or the tracking area updating accept message, and detecting a Restrict DCNR field corresponding to the first message; determining whether the Restrict DCNR field represents a status message indicating a grant to connect to the 5G network; if the Restrict DCNR field represents a status message indicating that it is not allowed to connect to the 5G network, determining the electronic device as being unable to connect to the 5G network; if the Restrict DCNR field represents a status message indicating a grant to connect to the 5G network, determining the electronic device as being able to connect to the 5G network.

The connecting unit 502 is configured for sending an attach request to a 5G network cell and receiving a connection result returned based on the attach request if the electronic device can connect to the 5G network.

Specifically, the connecting unit 502 is configured for receiving a measurement control message sent via the 4G network; detecting 5G cells neighboring the 4G network based on the measurement control message, and sending a measurement report of the 5G neighboring cells; sending the attach request to the 5G network cell among the 5G neighboring cells, wherein the 5G network cell is determined from the 5G neighboring cells based on the measurement report by the 4G network; receiving the connection result returned based on the attach request.

When performing the sending the attach request to the 5G network cell among the 5G neighboring cells, the connecting unit 502 is configured for receiving radio resource control reconfiguration and bearer configuration messages of the 5G network cell sent via the 4G network; detecting whether the radio resource control reconfiguration and the bearer configuration are finished; after the radio resource control reconfiguration and the bearer configuration are finished, receiving a random access configuration message sent by the 5G network cell and sending the attach request for random access to the 5G network cell based on the random access configuration message; determining the connection result as being a connection failure if it is detected that the radio resource control reconfiguration and the bearer configuration are not finished.

The display determining unit 503 is configured for determining based on the connection result whether the electronic device has an icon displayed as 5G; and determining the icon of the electronic device to be displayed as 4G if the electronic device is unable to connect to the 5G network.

Specifically, the display determining unit 503 is configured for determining to display the icon of the electronic device as 5G if the connection result shows a successful connection; determining to display the icon of the electronic device as 4G if the connection result shows a connection failure.

When performing the determining to display the icon of the electronic device as 5G the display determining unit 503 is configured for determining to display the icon of the electronic device as 5G if a frequency band used to connect to the 5G network cell belongs to a first frequency band; determining to display the icon of the electronic device as 5G ultra wideband if the frequency band used to connect to the 5G network cell belongs to a second frequency band.

During specific implementation, the foregoing modules and/or units may be implemented as independent entities, or may be implemented as one or more entities through random combination. For specific implementation of the foregoing modules and/or units, refer to the above method embodiments. For technical effects that can be achieved by the foregoing modules and/or units, also refer to the technical effects described in the above method embodiments. And details on these are not described herein again.

In addition, an embodiment of the present application also provides an electronic device. The electronic device may be a device such as a smartphone, a tablet computer and a robot. As shown in FIG. 7, the electronic device 600 includes a processor 601 and a storage 602. The processor 601 and the storage 602 are electrically connected to each other.

The processor 601 functions as a control center of the electronic device 600 and is configured to connect each component of the electronic device using various interfaces and circuits, and is configured to execute or load application programs stored in the storage 602, to call the data stored in the storage 602 and to execute various functions of the electronic device and perform data processing, thereby monitoring the overall electronic device.

In the present embodiment, the processor 601 of the electronic device 600 will load the instructions corresponding to a process of one or more than one application programs into the storage 602 based on the following steps, and the processor 601 will execute the application program stored in the storage 602 to realize various functions:

detecting whether the electronic device can connect to a 5G network when the electronic device connects to a 4G network;

if the electronic device can connect to the 5G network, sending an attach request to a 5G network cell, and receiving a connection result returned based on the attach request; and

determining based on the connection result whether the electronic device has an icon displayed as 5G.

The electronic device can implement the steps in any embodiment of the icon display method provided in the embodiments of the present application and can thus achieve the technical effects that can be achieved by any icon display method provided in the embodiments of the present invention. Please refer to the foregoing embodiments, and this is not described herein again.

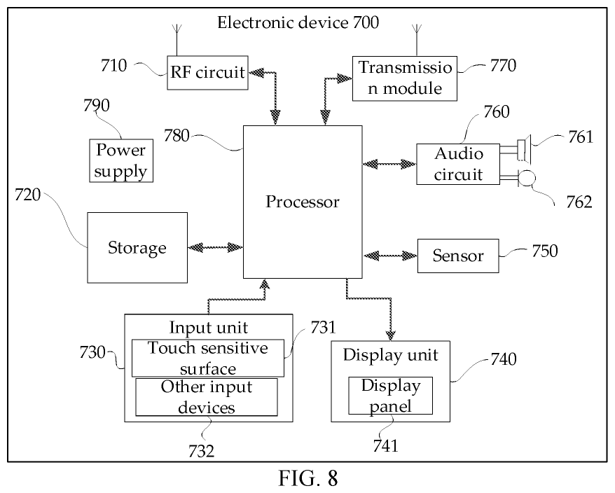

FIG. 8 is a structural block diagram showing an electronic device provided in an embodiment of the present invention. The electronic device can be utilized to implement the icon display method provided in above embodiments. The electronic device 700 can be a mobile terminal, a wearable device, a PC terminal, a robot, etc. The electronic device is able to connected to a network.

The RF circuit 710 is configured to receive and transmit electromagnetic waves to implement conversion between the electromagnetic waves and electrical signals, thereby communicating with a communication network or any other device. The RF circuit 710 may include various existing circuit components for executing the functions, for example, an antenna, an RF transceiver, a digital signal processor, an encryption/decryption chip, a subscriber identity module (SIM) card, a storage, and so on. The RF circuit 710 can communicate with various networks, such as internet, an intranet, or a wireless network, or can communicate with other devices via the wireless network. The above-mentioned wireless network may include a cellular network or a wireless local area network or metropolitan area network. The above-mentioned wireless network may use any one of communication standards, protocols, or technologies, including but not limited to Global System for Mobile communications (GSM), Enhanced Data GSM Environment (EDGE), Wideband Code Division Multiple Access (WCDMA), Code Division Multiple Access (CDMA), Time Division Multiple Access (TDMA), WIFI (such as standards of the Institute of Electrical and Electronics Engineers including IEEE802.11a, IEEE802.11b, IEEE 802.11g, and/or IEEE 802.11n), Voice over Internet Protocol (VoIP), Worldwide Interoperability for Microwave Access (Wi-Max), any other protocol for mails, instant communication, and short messages, any other suitable communication protocol, or any other protocol which has not been developed.

The storage 720 can be configured to store software programs and modules, such as the program instructions/modules corresponding to above embodiments. The processor 780 can perform various applications of functions and data processing by executing the software programs and modules stored in the storage 720. The storage 720 may include high-speed random access memory, and may further include non-volatile memory such as one or more magnetic storage devices, a flash memory, or other non-volatile solid state storage. In some embodiments, the storage 720 also includes a remote storage disposed corresponding to the processor 780. The remote storage may be linked to the electronic device 700 via a network. The network may include but not limited to at least one combination of internet, an intranet, a local area network, and a mobile communication network.

The input unit 730 can be configured to receive input numbers or character information, and generate signal input of a keyboard, a mouse, a joystick, or an optical trackball in relation to user settings and functional control. Specifically, the input unit 730 may include a touch sensitive surface 731 and any other input device 732. The touch sensitive surface 731, which is also called a touch screen or a touchpad, can gather a touch operation (for example, operations by use of a finger of a user, a stylus, and any other suitable object or attachment on or near the sensitive surface 731) applied on or near to the touch sensitive surface 731 by the user and drive a connected device according to preset programs. Optionally, the touch sensitive surface 731 may include a touch-sensitive device and a touch controller. The touch-sensitive device detects a direction of the user's touch, detects signals resulted from the touch operation, and transmits the signals to the touch controller. The touch controller receives information of the touch from the touch-sensitive device, converts it into a touch coordinate, further transmits the coordinate to the processor 780, and further receives and executes an instruction from the processor 780. Furthermore, the touch sensitive surface 731 may be implemented by utilizing capacitive, resistive, infrared, and surface acoustic wave technologies. In addition to the touch sensitive surface 731, the input unit 730 may further include any other input device 732. Specifically, the input device 732 may include but not limited to one or any of the combination of a physical keyboard, function keys (such as volume control keys, switch keys, etc.), a trackball, a mouse, and a joystick.

The display unit 740 may be configured to display information inputted by the user, information provided for the user, or various types of graphical user interfaces of the mobile terminal 700. The graphical user interfaces may include a graph, a text, an icon, a video, and any combination of them. The display unit 740 may include a display panel 741, optionally, which may be a liquid crystal display (LCD) or an Organic Light-Emitting Diode (OLED) display. Furthermore, the touch sensitive surface 731 may cover the display panel 741. When the touch sensitive surface 731 detects a touch operation on or near the touch sensitive surface 731 and transmits a corresponding signal to the processor 780 to determine a type of the touch event, the processor 780 controls the display panel 741 to provide appropriate visual output according to the type of the touch event. Although the touch sensitive surface 731 and the display panel 741 in the figure are two separate components for implementing input and output functions, the touch sensitive surface 731 and the display panel 741 may be integrated into one component for implementing the input and output functions in some embodiments.

The electronic device 700 may further include at least one sensor 750, such as a light sensor, a motion sensor, and other sensors. Specifically, the light sensor can include an ambient light sensor and a proximity sensor. The ambient light sensor can adjust the brightness of the display panel 741 according to bright or dark as to the ambient light. The proximity sensor can generate an interrupt when a cover is closed or turned off. As one type of the motion sensor, a gravity sensor (G-sensor) can detect acceleration speed on all directions (generally up to three axis), can detect magnitude and direction of the gravity when it stays still, and can identify a gesture in a cell phone application (such as a screen switch between landscape style and portrait style, relevant games, and magnetometer calibration) and recognize vibration patterns to identify relevant functions (such as pedometer, and knock), and so on. Additionally, a gyroscope, a barometer, a hygrometer, a thermometer, an infrared sensor, and any other sensor can be deployed in the electronic device 700, and the details for these are not repeated herein.

The audio circuit 760, a speaker 761, and a microphone 762 provide an audio interface between the user and the electronic device 700. The audio circuit 760 converts received audio data to an electrical signal and transmits the electrical signal to the speaker 761. The speaker 761 converts the electrical signal to sound signals and outputs the sound signals. In addition, the microphone 762 converts collected sound signal to an electrical signal. The audio circuit 760 converts the electrical signal to audio data and transmits the audio data to the processor 780 for further processing. After the processing, the audio data may be transmitted to another terminal via the RF circuit 710, or transmitted to the storage 720 for further processing. The audio circuit 760 may further include an earphone jack for providing communication between an external earphone and the electronic device 700.

By the transmission module 770 (such as a WIFI module), the electronic device 700 can help a user receive a request, send a message and so on. It provides the user with wireless broadband internet access. It should be understood that although the transmission module 770 is illustrated in the figure, this module is not an essential component for the electronic device 700 and can be omitted according to needs without departing from the scope of the present invention.

The processor 780 functions as a control center of the electronic device 700 and is configured to connect each component of the cell phone using various interfaces and circuits, and is configured to execute the various functions of the electronic device 700 and to perform data processing by running or executing the software programs and/or modules stored in the storage 720 and calling the data stored in the storage 720, thereby monitoring the overall electronic device. Optionally, the processor 780 can include one or more processing cores. In some embodiments, an application processor and a modulation/demodulation processor can be integrated to form the processor 780. The application processor is primarily configured to process an operating system, user interfaces, application programs, and so on. The modulation/demodulation processor is primarily configured to process wireless communication. It should be understood that the modulation/demodulation processor can be independent from the processor 780.

The electronic device 700 further includes the power supply 790 (such as a battery) configured to provide power for the various components. In some embodiments, the power supply can be logically coupled to the processor 780 via a power management system that controls charging, discharging, power consumption, and so on. The power supply 790 may further include one or more direct current (DC)/or alternating current (AC) power sources, recharging system, power failure detection circuit, power converter or inverter, power supply status indicator, and the like.

Although not being shown, the electronic device 700 may include a camera (such as a front camera and a rear camera), a BLUETOOTH module, and so on. They are not repeated herein. In the present embodiment, a display unit of the mobile terminal is a display with a touch screen. The mobile terminal further includes a storage and one or more programs. The one or more programs are stored in the storage. After configuration, one or more processors execute the one or more programs, which include the following operating instructions:

detecting whether the electronic device can connect to a 5G network when the electronic device connects to a 4G network;

if the electronic device can connect to the 5G network, sending an attach request to a 5G network cell, and receiving a connection result returned based on the attach request; and

determining based on the connection result whether the electronic device has an icon displayed as 5G.

During specific implementation, the foregoing modules may be implemented as independent entities, or may be implemented as one or more entities through random combination. For specific implementation of the foregoing modules, refer to the above method embodiments, and details are not described herein again.

A person of ordinary skill in the art may understand that all or some of the steps in various methods of the foregoing embodiments may be implemented by program instructions, or may be implemented by a program instructing relevant hardware. The program instructions may be stored in a computer readable storage medium, and be loaded and executed by a processor. For this, an embodiment of the present invention provides a storage medium, which stores a plurality of instructions that can be loaded by the processor to execute the steps of any of the icon display methods provided in the embodiments of the present invention.

The storage medium may include a read only memory (ROM), a random access memory (RAM), a magnetic disk or an optic disc.

Since the program instructions stored in the storage medium can execute the steps of any of the icon display methods provided in the embodiments of the present invention, it can realize the beneficial effects achieved by any of the icon display methods provided in the embodiments of the present invention, which are referred to above embodiments and are not repeated herein.

The icon display method, apparatus, storage medium and electronic device provided in the embodiments of the present application are described in detail above. The principle and implementation of the present application are described herein through specific examples. The description about the embodiments of the present application is merely provided to help understanding the method and core ideas of the present application. In addition, persons of ordinary skill in the art can make variations and modifications to the present application in terms of the specific implementations and application scopes according to the ideas of the present application. Therefore, the content of specification shall not be construed as a limit to the present application.

1. An icon display method, applied in an electronic device, comprising:
detecting whether the electronic device can connect to a 5G network when the electronic device connects to a 4G network;
if the electronic device can connect to the 5G network, sending an attach request to a 5G network cell, and receiving a connection result returned based on the attach request; and
determining based on the connection result whether the electronic device has an icon displayed as 5G.

2. The icon display method of claim 1, wherein the detecting whether the electronic device can connect to the 5G network comprises:
obtaining a system message and a first message sent by the 4G network and received by the electronic device, and a second message sent by the electronic device;
if the system message comprises a status message indicating that connection to the 4G network and the 5G network is supported, the first message is a status message indicating a grant to connect to the 5G network and the second message is a status message indicating that a capability to connect to the 5G network is equipped, determining the electronic device as being able to connect to the 5G network;
otherwise, determining the electronic device as being unable to connect to the 5G network.

3. The icon display method of claim 1, further comprising:
if the electronic device is unable to connect to the 5G network, determining to display the icon of the electronic device as 4G.

4. The icon display method of claim 1, wherein the determining based on the connection result whether the electronic device has the icon displayed as 5G comprises:
if the connection result shows a successful connection, determining to display the icon of the electronic device as 5G;
if the connection result shows a connection failure, determining to display the icon of the electronic device as 4G.

5. The icon display method of claim 4, wherein the determining to display the icon of the electronic device as 5G comprises:
if a frequency band used to connect to the 5G network cell belongs to a first frequency band, determining to display the icon of the electronic device as 5G;
if the frequency band used to connect to the 5G network cell belongs to a second frequency band, determining to display the icon of the electronic device as 5G ultra wideband.

6. The icon display method of claim 1, wherein the sending the connection result to the 5G network cell and receiving the connection result returned based on the connection result comprises:
receiving a measurement control message sent via the 4G network;
detecting 5G cells neighboring the 4G network based on the measurement control message, and sending a measurement report of the 5G neighboring cells;
sending the attach request to the 5G network cell among the 5G neighboring cells, wherein the 5G network cell is determined from the 5G neighboring cells based on the measurement report by the 4G network;
receiving the connection result returned based on the attach request.

7. The icon display method of claim 6, wherein the sending the attach request to the 5G network cell among the 5G neighboring cells comprises:
receiving radio resource control reconfiguration and bearer configuration messages of the 5G network cell sent via the 4G network;
detecting whether the radio resource control reconfiguration and the bearer configuration are finished;
after the radio resource control reconfiguration and the bearer configuration are finished, receiving a random access configuration message sent by the 5G network cell and sending the attach request for random access to the 5G network cell based on the random access configuration message.

8. An icon display apparatus, applied in an electronic device,
comprising a processor and a storage that are electrically connected to each other, wherein the storage is configured to store instructions and data, and the processor is configured to execute the following steps:
detecting whether the electronic device can connect to a 5G network when the electronic device connects to a 4G network;
sending an attach request to a 5G network cell and receiving a connection result returned based on the attach request if the electronic device can connect to the 5G network; and
determining based on the connection result whether the electronic device has an icon displayed as 5G.

9. The icon display apparatus of claim 8, wherein the detecting whether the electronic device can connect to the 5G network comprises:
obtaining a system message and a first message sent by the 4G network and received by the electronic device, and a second message sent by the electronic device;
if the system message comprises a status message indicating that connection to the 4G network and the 5G network is supported, the first message is a status message indicating a grant to connect to the 5G network and the second message is a status message indicating that a capability to connect to the 5G network is equipped, determining the electronic device as being able to connect to the 5G network;
otherwise, determining the electronic device as being unable to connect to the 5G network.

10. The icon display apparatus of claim 8, further comprising determining to display the icon of the electronic device as 4G if the electronic device is unable to connect to the 5G network.

11. The icon display apparatus of claim 8, wherein the determining based on the connection result whether the electronic device has the icon displayed as 5G comprises:
if the connection result shows a successful connection, determining to display the icon of the electronic device as 5G;
if the connection result shows a connection failure, determining to display the icon of the electronic device as 4G.

12. The icon display apparatus of claim 11, wherein the determining to display the icon of the electronic device as 5G comprises:
if a frequency band used to connect to the 5G network cell belongs to a first frequency band, determining to display the icon of the electronic device as 5G;
if the frequency band used to connect to the 5G network cell belongs to a second frequency band, determining to display the icon of the electronic device as 5G ultra wideband.

13. The icon display apparatus of claim 8, wherein the sending the connection result to the 5G network cell and receiving the connection result returned based on the connection result comprises:
receiving a measurement control message sent via the 4G network;
detecting 5G cells neighboring the 4G network based on the measurement control message, and sending a measurement report of the 5G neighboring cells;
sending the attach request to the 5G network cell among the 5G neighboring cells, wherein the 5G network cell is determined from the 5G neighboring cells based on the measurement report by the 4G network;
receiving the connection result returned based on the attach request.

14. The icon display apparatus of claim 13, wherein the sending the attach request to the 5G network cell among the 5G neighboring cells comprises:
receiving radio resource control reconfiguration and bearer configuration messages of the 5G network cell sent via the 4G network;
detecting whether the radio resource control reconfiguration and the bearer configuration are finished;
after the radio resource control reconfiguration and the bearer configuration are finished, receiving a random access configuration message sent by the 5G network cell and sending the attach request for random access to the 5G network cell based on the random access configuration message.

15. A computer readable storage medium, wherein the storage medium stores a plurality of instructions applicable to be loaded by a processor to execute the steps of:
detecting whether the electronic device can connect to a 5G network when the electronic device connects to a 4G network;
if the electronic device can connect to the 5G network, sending an attach request to a 5G network cell, and receiving a connection result returned based on the attach request; and
determining based on the connection result whether the electronic device has an icon displayed as 5G.

16. The computer readable storage medium of claim 15, wherein when performing the detecting whether the electronic device can connect to the 5G network, the processor performs the following steps:
obtaining a system message and a first message sent by the 4G network and received by the electronic device, and a second message sent by the electronic device;
if the system message comprises a status message indicating that connection to the 4G network and the 5G network is supported, the first message is a status message indicating a grant to connect to the 5G network and the second message is a status message indicating that a capability to connect to the 5G network is equipped, determining the electronic device as being able to connect to the 5G network;
otherwise, determining the electronic device as being unable to connect to the 5G network.

17. The computer readable storage medium of claim 15, wherein the processor further performs the following step:
if the electronic device is unable to connect to the 5G network, determining to display the icon of the electronic device as 4G.

18. The computer readable storage medium of claim 15, wherein when performing the determining based on the connection result whether the electronic device has the icon displayed as 5G, the processor performs the following steps:
if the connection result shows a successful connection, determining to display the icon of the electronic device as 5G;
if the connection result shows a connection failure, determining to display the icon of the electronic device as 4G.

19. The computer readable storage medium of claim 18, wherein when performing the determining to display the icon of the electronic device as 5G, the processor performs the following steps:
if a frequency band used to connect to the 5G network cell belongs to a first frequency band, determining to display the icon of the electronic device as 5G;
if the frequency band used to connect to the 5G network cell belongs to a second frequency band, determining to display the icon of the electronic device as 5G ultra wideband.

20. The computer readable storage medium of claim 15, wherein when performing the sending the connection result to the 5G network cell and receiving the connection result returned based on the connection result, the processor performs the following steps:
receiving a measurement control message sent via the 4G network;
detecting 5G cells neighboring the 4G network based on the measurement control message, and sending a measurement report of the 5G neighboring cells;
sending the attach request to the 5G network cell among the 5G neighboring cells, wherein the 5G network cell is determined from the 5G neighboring cells based on the measurement report by the 4G network;
receiving the connection result returned based on the attach request.
